(19) United States
(12) Patent Application Publication
(10) Pub. No.: US 2025/0241490 A1
(43) Pub. Date: Jul. 31, 2025

(54) HANDHELD BATTERY POWERED GRATER

(71) Applicant: James B. Olmes, Agoura Hills, CA (US)

(72) Inventor: James B. Olmes, Agoura Hills, CA (US)

(21) Appl. No.: 19/042,649

(22) Filed: Jan. 31, 2025

Related U.S. Application Data
(60) Provisional application No. 63/627,604, filed on Jan. 31, 2024.

(51) Int. Cl. A47J 43/25

(52) U.S. Cl. CPC A47J 43/255

(57) ABSTRACT

A handheld battery powered grater includes a power handle and a product container. A motor within the power handle drives a crankshaft that rotates a product within the product container against a non-rotating blade to cause the product to be grated by the non-rotating blade and emitted from a bottom end of the handheld battery powered grater. A spring within the product container provides a continuous force to press the product against the blade. The product container detaches from the power handle and may be sealed by a sealing cap for easy storage in a refrigerator. A stand for the handheld battery powered grater includes a recharging cable that may recharge a battery of the handheld battery powered grater positioned in the stand. The sealing cap also stored additional blades that are easily interchangeable.

### RELATED APPLICATION

This application claims priority to U.S. Provisional Patent Application No. 63/627,604, entitled “Handheld Battery Powered Grater,” filed Jan. 31, 2024, which is hereby incorporated by reference in its entirety.

### BACKGROUND

Manual graters are not easily used when grating a hard product such as a hard cheese, particularly by the elderly.

### SUMMARY

One aspect of the present embodiments includes the realization that grating a hard product can be difficult, particular when older or disabled. The present embodiments solve this problem by providing a handheld battery powered grater that is easily used single handedly. Advantageously, the handheld battery powered grater is easy to load with the product, and is also easily to maintain and clean. Further, a product container portion of the handheld battery powered grater may be detached from its power handle, sealed, and stored in the refrigerator, such that it is unnecessary to remove the product from the grater and to clean it after every use.

Another aspect of the present embodiments includes the realization that loose components are easily lost. The present embodiments solve this problem by including component storage within the handheld battery powered grater and/or its stand. For example, spare grating blades may be stored in a sealing cap that is used to seal the product container portion of the handheld battery powered grater. The sealing cap may also couple with the stand. A charging cord may be stored on a spool within the stand. Advantageously, these components are stored with the handheld battery powered grater, making loss less likely.

In certain embodiments, the techniques described herein relate to a handheld battery powered grater, including: a power handle with a battery, a motor, and a button; and a product container removably coupled with the power handle and having: an internal mechanism that rotates; and a non-rotating blade positioned at a distal end of the product container from the power handle; wherein activation of the button transfers electrical power from the battery to the motor to cause the internal mechanism to rotate such that a product within the product container is rotated against the non-rotating blade.

In certain embodiments, the techniques described herein relate to a method for grating a product, including: applying a continuous force to one end of a product to press an opposite end of the product against a non-rotating blade; activating a battery powered motor in response to a button being pressed; and rotating the product by the battery powered motor to cause the non-rotating blade to grate the product.

### BRIEF DESCRIPTION OF THE FIGURES

FIG. 1 is a front view of one example handheld battery powered grater, in embodiments.

FIG. 2 is a perspective view showing one example stand for holding the handheld battery powered grater of FIG. 1, in embodiments.

FIG. 3 is a front view showing the power handle of FIG. 1 positioned within the stand of FIG. 2 when the product container is detached from the power handle, in embodiments.

FIG. 4 shows the charging cable of FIG. 2 coupled with the power socket of the power handle, in embodiments.

FIG. 5 is a perspective view of the product container of FIG. 1 with an internal mechanism removed from an outer shell of the product container, in embodiments.

FIG. 6 is a perspective view showing a sealing cap of the product container of FIG. 1, in embodiments.

FIG. 7 is an exploded perspective diagram showing the power handle of FIG. 1 in further example detail, in embodiments.

FIG. 8 is an exploded perspective diagram showing the product container of FIGS. 1 and 5 in further example detail, in embodiments.

FIG. 9 is an exploded perspective diagram showing the sealing cap of FIG. 6 in further example detail, in embodiments.

FIG. 10 is an exploded perspective diagram showing the stand of FIG. 2, in further example detail, in embodiments.

FIG. 11 is a cross-sectional view illustrating assembly of the handheld battery powered grater of FIG. 1, the stand of FIG. 2, and the sealing cap of FIG. 6, in embodiments.

FIG. 12 is a manufacturer list of components and materials for the handheld battery powered grater of FIG. 1, the stand of FIG. 2, and the scaling cap of FIG. 6, as corresponding to FIGS. 7, 8, 9 and 10, in embodiments.

FIG. 13 is a flowchart illustrating one example method for grating a product with a handheld grater, in embodiments.

### DETAILED DESCRIPTION OF THE EMBODIMENTS

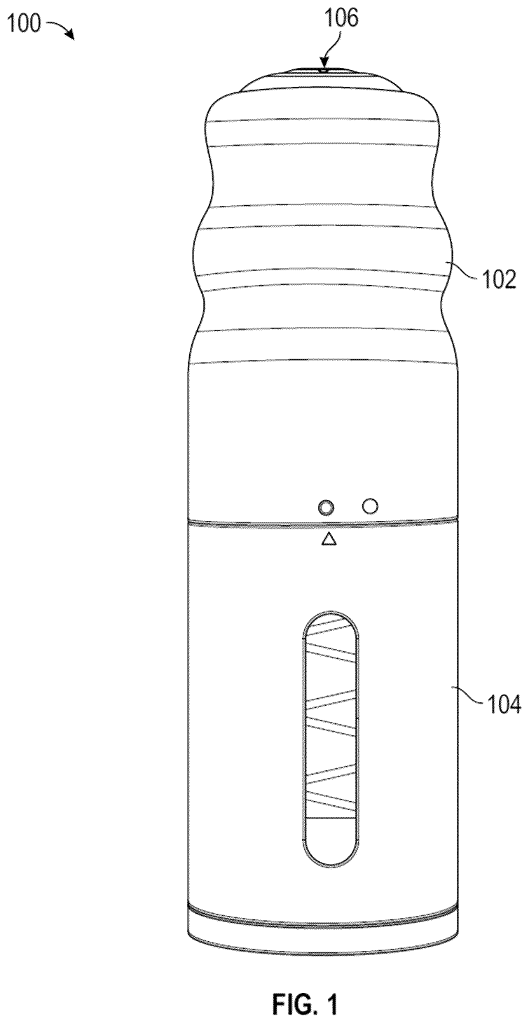

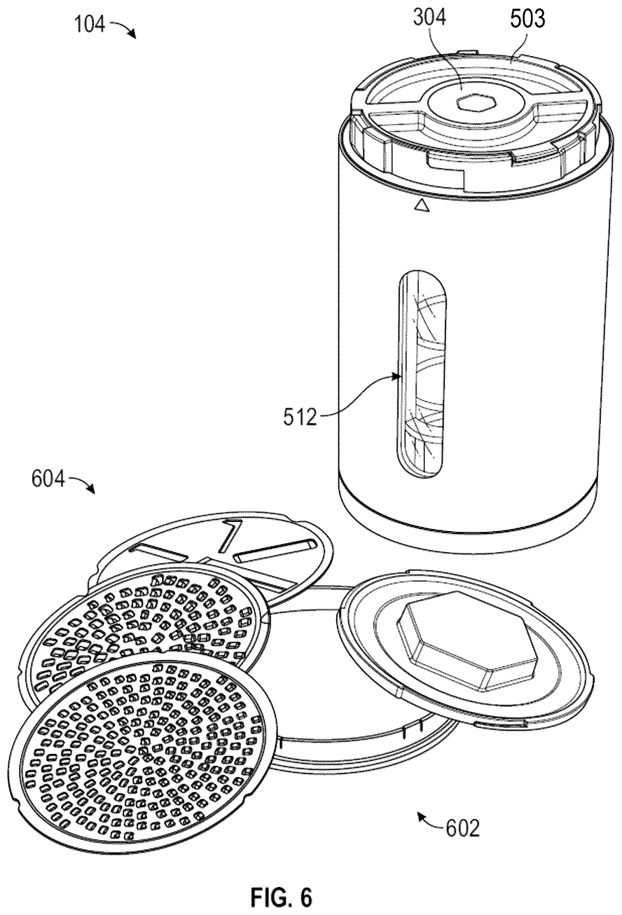

FIG. 1 is a front view of one example handheld battery powered grater 100, in embodiments. Handheld battery powered grater 100 has a power handle 102 and a product container 104 that are separable by a rotational movement. A product (e.g., one of a hard cheese, a chocolate, etc.) is loaded into product container 104 which is then coupled with power handle 102. Power handle 102 includes a button 106, that when pressed, causes handheld battery powered grater 100 to rotate the product against a non-rotating blade (e.g., see blades 604 of FIG. 6) held stationary (e.g., non-rotating) at a lower end of product container 104, such that grated product is emitted from the base of product container 104. Advantageously, handheld battery powered grater 100 allows the product to be grated single handedly, simply by pressing button 106.

Advantageously, handheld battery powered grater 100 dispenses a greater volume of produce as compared to other hand held graters, and particularly manually operated hand held graters. Further, handheld battery powered grater 100 is easier and more convenient to use than the other prior art graters. For example, manually operated prior art handheld graters are difficult to crank, particularly for harder products such as a hard cheese, and are especially difficult to operate by older users. Advantageously, handheld battery powered grater 100 solves these problems since button 106 is easily operated as handheld battery powered grater 100 and an internal rechargeable power source causes a product to be grates without further effort from the user.

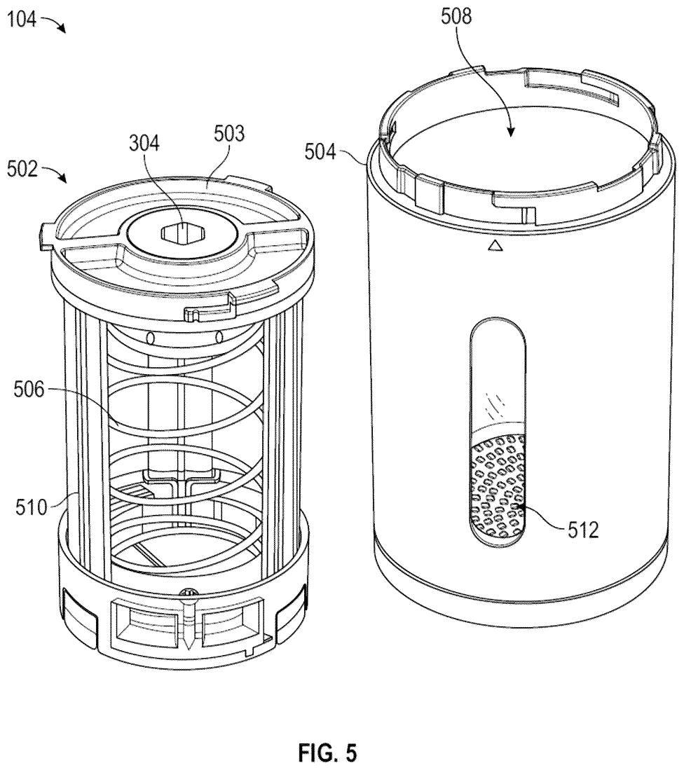

A further advantage of handheld battery powered grater 100 is that product container 104, which contains the product being grated, detaches from power handle 102 such that it may be stored within a refrigerator. A scaling cap (e.g., see scaling cap 602 of FIG. 6) attaches to the bottom of product container 104 to provide a seal such that the product stays fresh while remaining within product container 104. This alleviates the need to remove the product from product container 104 after use, whereby the product is stored within product container 104, which is easily placed within a refrigerator. This allows a user to quickly remove product container 104 from the refrigerator, remove sealing cap 602, couple product container 104 with power handle 102 and start grating the product. Advantageously, power handle 102 may couple with different product containers 104, allowing the user to buy multiple product containers 104 for use with one power handle 102, such that different products in different product containers 104 are conveniently stored in the refrigerator and taken out and coupled with power handle 102 as needed. Advantageously, by scaling product container 104 using scaling cap 602 and storing product container 104 within the refrigerator, washing between each use is unnecessary. Advantageously, substantially all of product placed into product container 104 is grated by handheld battery powered grater 100. As product runs low, a user may simply add more product to container bucket 508 and continue use. A viewing window 512 (see FIG. 5) within product container 104 allows the user to see how much product is within product container 104.

All of the parts of handheld battery powered grater 100 are serviceable and/or replaceable, and handheld battery powered grater 100 may be provided with a two-year warranty.

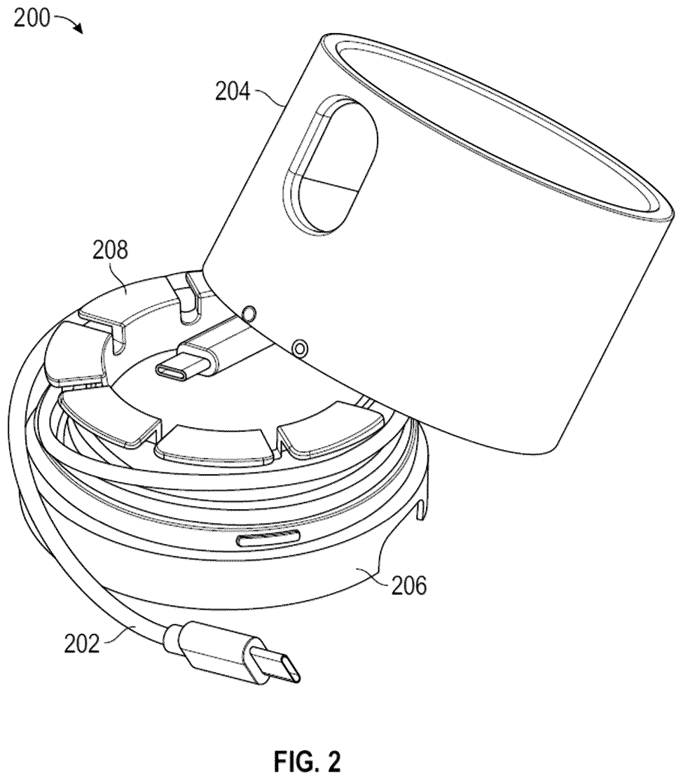

FIG. 2 is a perspective view showing one example stand 200 for holding handheld battery powered grater 100 of FIG. 1, in embodiments. Stand 200 is shown with an outer shell 204 removed from a base 206 to reveal a conveniently stored charging cable 202, wound around a spool 208, that may be removed to recharge a rechargeable battery of power handle 102. Stand 200 may hold either handheld battery powered grater 100 (e.g., power handle 102 coupled with product container 104), or just power handle 102. Advantageously, stand 200 provides a home for power handle 102 while product container 104 is stored in the refrigerator. Further, storing charging cable 202 in stand 200 helps prevent loss of cable 202.

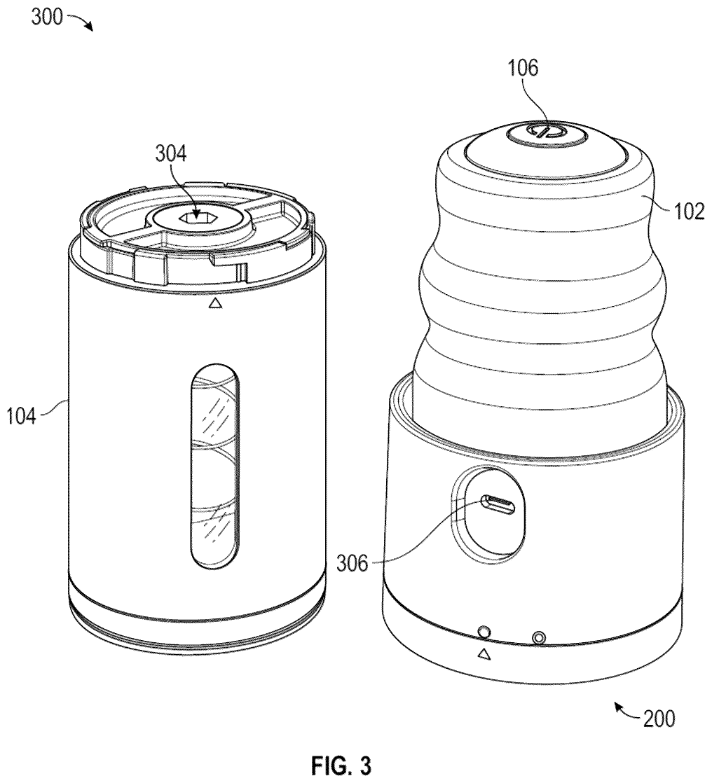

FIG. 3 is a front view showing power handle 102 of FIG. 1 positioned within stand 200 of FIG. 2 when product container 104 is detached from power handle 102, in embodiments. Power handle 102 provides rotational power to product container 104 via a drive shaft 304. Power handle 102 also includes a power socket 306 (e.g., USB-C socket) for coupling with a plug of cable 202 to recharge batteries of power handle 102.

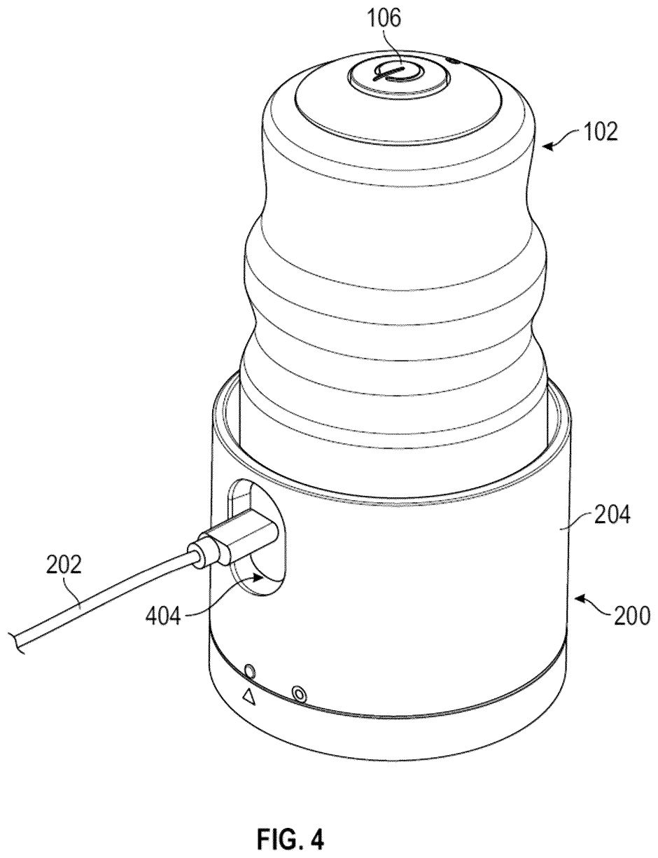

FIG. 4 shows charging cable 202 of FIG. 2 coupled with power socket 306 of power handle 102, in embodiments. As shown, stand 200 conveniently includes an aperture 404 that facilitates connecting of charging cable 202 to power handle 102 when positioned within stand 200. For example, aperture 404 is sized to allow a plug of cable 202 to pass through and connect to power socket 306 of power handle 102. Thus, stand 200 allows charging of power handle 102 while being stored on stand 200. Power handle 102 may include an LED that emits red light while battery 704 is charging, and emits green light when battery 704 is fully charged. The LED emits a light glow green light during operation of handheld battery powered grater 100 and emits a red light during operation when battery 704 is getting low on power and needs recharging.

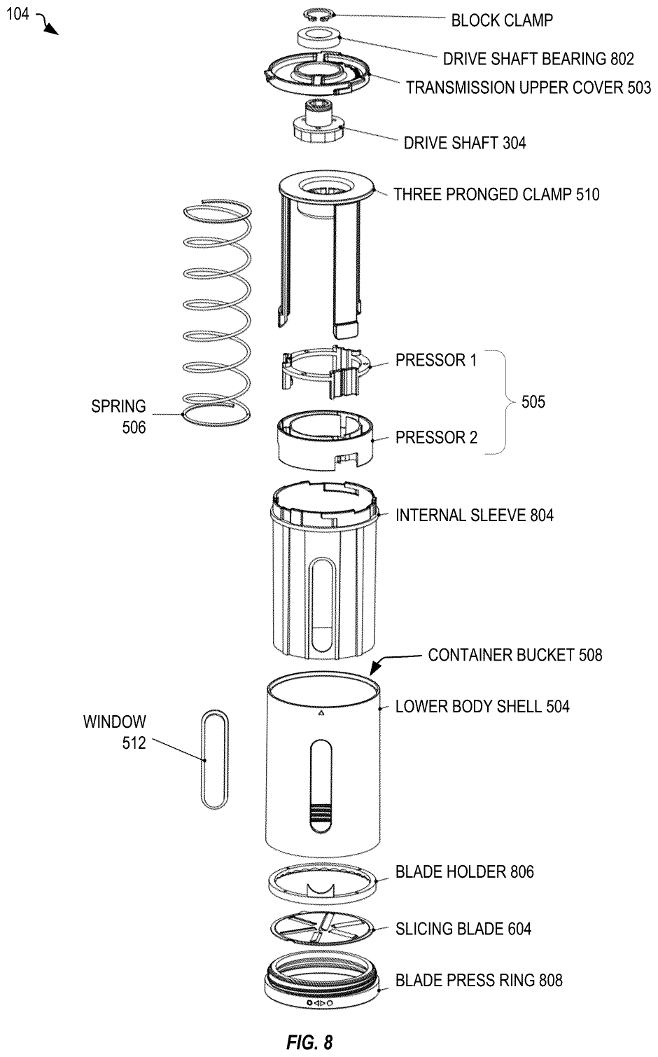

FIG. 5 is a perspective view of product container 104 of FIG. 1 with an internal mechanism 502 removed from an outer shell 504 of product container 104, in embodiments. FIG. 8 is an exploded perspective diagram showing product container 104 of FIGS. 1 and 5 in further example detail, in embodiments. FIGS. 5 and 8 are best viewed together with the following description.

Internal mechanism 502 includes a spring 506 for pressing the product, via a pressor 505, against a blade (e.g., see blade 604, FIG. 6) held at a lower end of outer shell 504, and a product clamp 510 (e.g., a three pronged clamp) that grips the product for rotation. Spring 506 is positioned between pressor 505 and an power handle end of product clamp 510. Outer shell 504 forms a container bucket 508 for receiving a product for grating. In one example of operation, a product is placed into container bucket 508, and internal mechanism 502 pushed into outer shell 504 causing spring 506 to compress as pressor 505 contacts the product. Internal mechanism 502 is retained within outer shell 504 by a rotational lock mechanism between an upper cover 503 of internal mechanism 502 and outer shell 504. Product clamp 510 is rotated by drive shaft 304 independently of upper cover 503 (e.g., see drive shaft bearing 802 of FIG. 8) that allows drive shaft 304 to rotate independently of upper cover 503. Spring 506 provides a continuous force that causes pressor 505 to push the product against a blade (see blade 604, FIG. 8) at the lower end of outer shell 504.

Drive shaft 304 is mounted to upper cover 503 with a drive shaft bearing 802 and couples with product clamp 510 such that pressor 505, spring 506, and product clamp 510 are rotatable within an internal sleeve 804 that is positioned within outer shell 504 to form container bucket 508 and that does not rotate.

When product container 104 is coupled with power handle 102, drive shaft 304 is rotated (when button 106 is pressed) by power handle 102 to cause pressor 505 and product clamp 510 to rotate within internal sleeve 804. Product clamp 510 causes a product within container bucket 508 to rotate as spring 506 causes pressor 505 to press the product against the blade, thereby grating the product.

A blade holder 806 it fitted to a bottom end (e.g., a distal end from power handle 102) of outer shell 504. Blade 604 is then inserted into the bottom end against blade holder 806 and is immovably secured in place by a blade press ring 808. Blade holder 806 and blade press ring 808 hold blade 604 stationary (e.g., non-rotating) at the bottom end of outer shell 504. Blade press ring 808 is first removed (e.g., unscrewed) to release blade 604 for cleaning and/or to change to a different type of blade.

Advantageously, product container 104 easily disassembles for cleaning, and components that contact with the product are dishwasher safe. For example, internal mechanism 502, outer shell 504 and internal sleeve 804, and blade 604 are separable for cleaning and are formed of a material that is suitable for cleaning in a dishwasher.

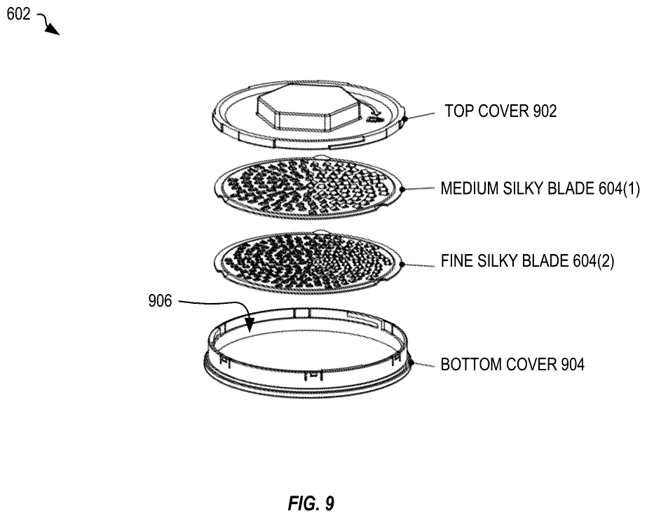

FIG. 6 is a perspective view showing a sealing cap 602 of product container 104 of FIG. 1, in embodiments. FIG. 9 is an exploded perspective diagram showing scaling cap 602 of FIG. 6 in further example detail, in embodiments. FIGS. 6 and 9 are best viewed together with the following description.

Scaling cap 602 includes a top cover 902 and a bottom cover 904 that couple together to form an enclosed volume 906 that may store at least one unused and/or additional blade 604 that is accessible when sealing cap 602 is removed from product container 104. For example, FIG. 6 shows sealing cap 602 removed from product container 104 and opened to reveal a medium, silky blade 604(1) and a fine silky blade 604(2) stored therein. With top cover 902 and bottom cover 904 coupled together, sealing cap 602 rotationally secures to blade press ring 808 at the lower end of product container 104 to cover the blade and seal container bucket 508 to keep the product therein fresh.

Blades 604 are interchangeable within product container 104 for different types of grating performance. In the example of FIG. 6, additional blades 604 include a shaving blade, a coarse grating blade, and a fine grating blade. Advantageously, unused blades are conveniently stored in sealing cap 602 to prevent loss and are easily accessible since they are stored with handheld battery powered grater 100.

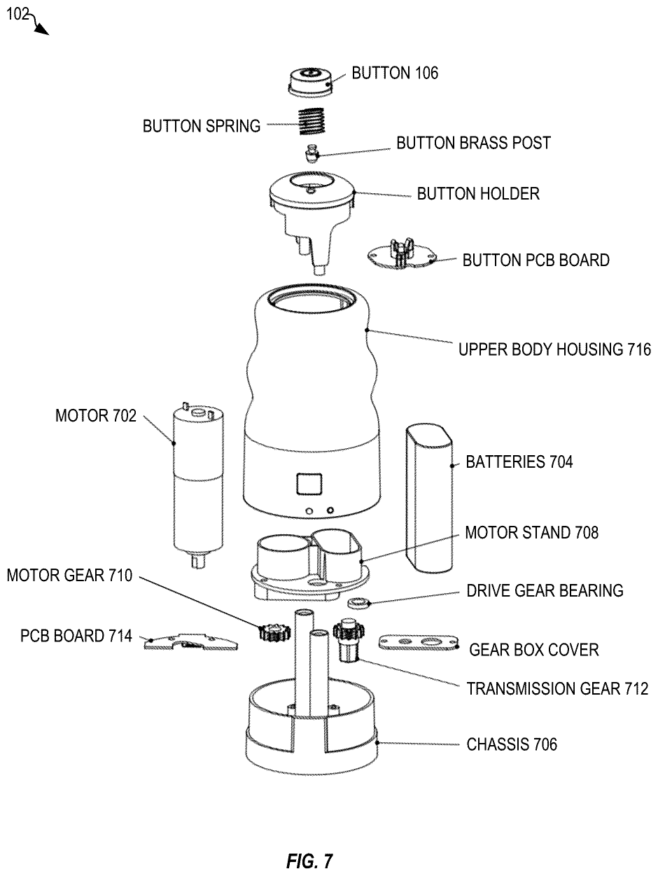

FIG. 7 is an exploded perspective diagram showing power handle 102 of FIG. 1 in further example detail, in embodiments. Power handle 102 includes a motor 702, and a battery 704 (e.g., a rechargeable battery). Button 106 is positioned on top of power handle 102 for easy operation, but could be positioned elsewhere without departing from the scope hereof. Battery 704 is for example a powerful lithium rechargeable battery that drives motor 702 with sufficient power and duration to enable handheld battery powered grater 100 to grate several pounds of product between charging. Power handle 102 also includes an internal chassis 706, a motor stand 708, a motor gear 710 couples to a shaft of motor 702, a transmission gear 712 with a hexagonal shaft that is driven by motor gear 710, a PCB circuit board 714 that receives power from battery 704 and drives motor 702 when button 106 is pressed. Power handle 102 includes an upper body housing 716 that forms an external cover for motor 702, battery 704, internal chassis 706, motor stand 708, motor gear 710, transmission gear 712, and PCB circuit board 714, and may be shaped and textured to facilitate holding of handheld battery powered grater 100 in one hand. In one example of operation, activation of button 106 transfers electrical power from battery 704 to motor 702, causing motor 702 to rotate motor gear 710, which in turn drives transmission gear 712. As shown in FIG. 3, power handle 102 includes a power socket 306 that allows battery 704 to be recharged.

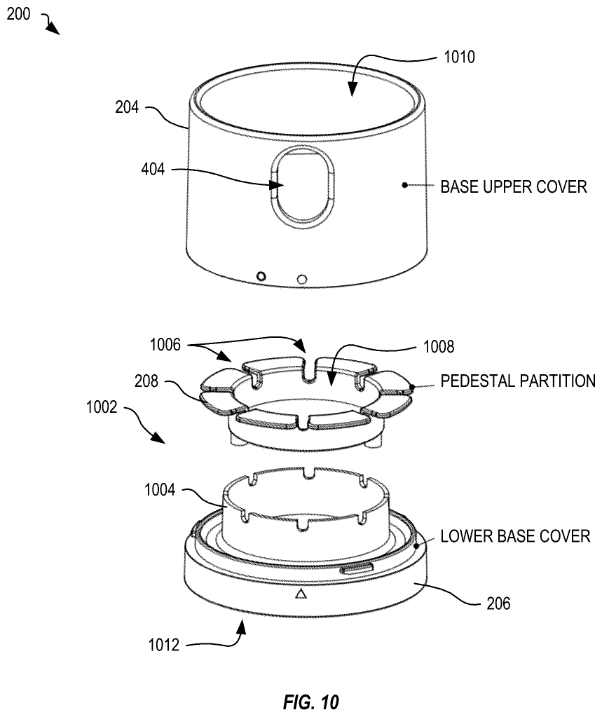

FIG. 10 is an exploded perspective diagram showing stand 200 of FIG. 2, in further example detail, in embodiments. FIG. 10 does not show charging cable 202 for clarity of illustration. Base 206 attaches to outer shell 204 by a rotational lock mechanism to form an internal chamber 1002 with an internal structure 1004. Base 206 may be removed from outer shell 204 to internal structure 1004. Spool 208 is secured with internal structure 1004 and includes a plurality of slots 1006 (e.g., notches) that allow ends (e.g., plugs) of cable 202 to be positioned within a center area 1008 of spool 208.

Stand 200 forms an upper opening 1010 that is sized to receive power handle 102, as shown in FIGS. 3 and 4, and may also receive handheld battery powered grater 100 (e.g., power handle 102 coupled with product container 104). An underside 1012 of base 206 may be recessed to receive sealing cap 602 (e.g., by a rotational lock mechanism) should the user prefer to store additional blades 604 with stand 200. For example, the user may couple scaling cap 602 with base 206 instead of with product container 104. Alternatively, the user may have two scaling caps 602, where one attaches to product container 104 and the other attaches to stand 200.

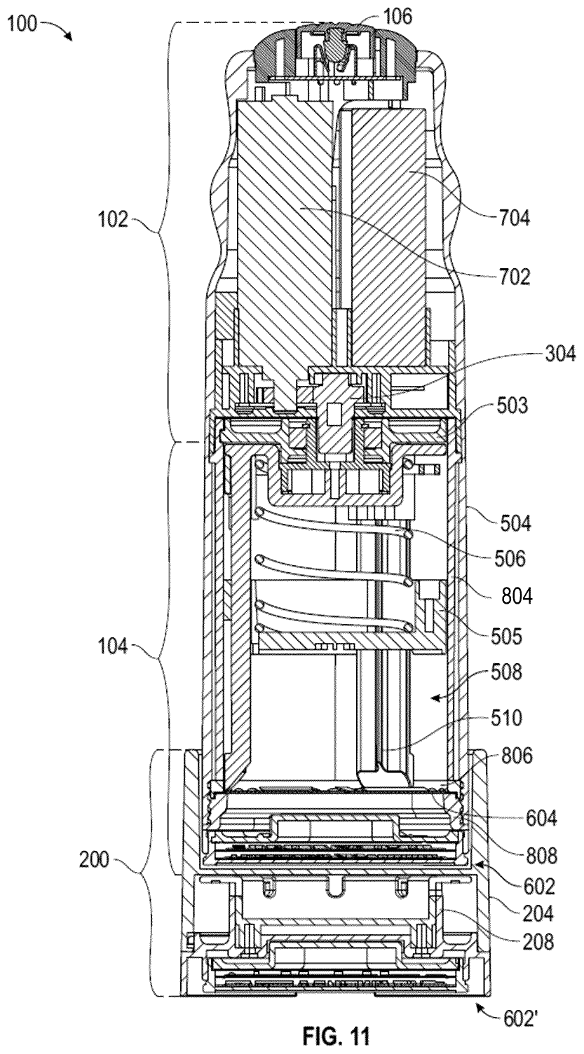

FIG. 11 is a cross-sectional view illustrating assembly of handheld battery powered grater 100 of FIG. 1, stand 200 of FIG. 2, and scaling cap 602 of FIG. 6, in embodiments.

Power handle 102 includes a motor 702, a button 106, and power socket 306 for charging battery 704 (not shown). Product container 104 has outer shell 504 and internal mechanism 502 that forms container bucket 508 for holding the product. For example, product clamp 510 has multiple arms (e.g., three arms) that contact the product and cause it to rotate when internal mechanism 502 is rotated by motor 702 of power handle 102.

Sealing cap 602 also stores additional blades 604 and attaches to outer shell 504 of product container 104, or may couple to a lower end of stand 200 (indicated as part 602′).

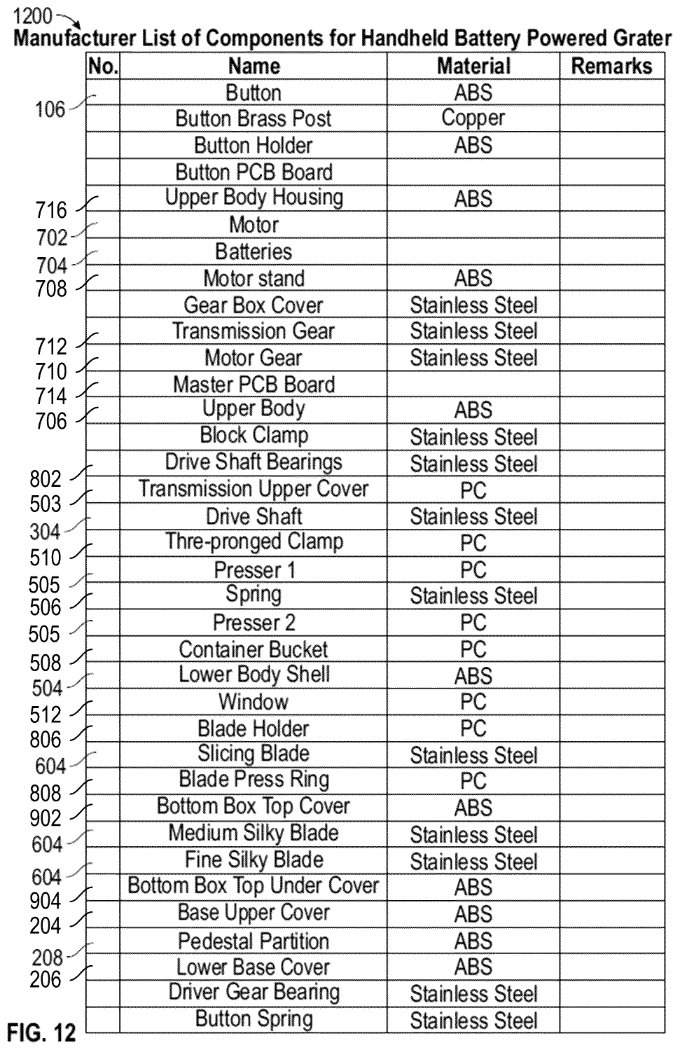

FIG. 12 is a manufacturer list 1200 of components and materials for handheld battery powered grater 100 of FIG. 1, stand 200 of FIG. 2, and scaling cap 602 of FIG. 6, as corresponding to FIGS. 7, 8, 9 and 10, in embodiments. List 1200 illustrates example material used for manufacture of different components of handheld battery powered grater 100; however, other material may be used without departing from the scope hereof.

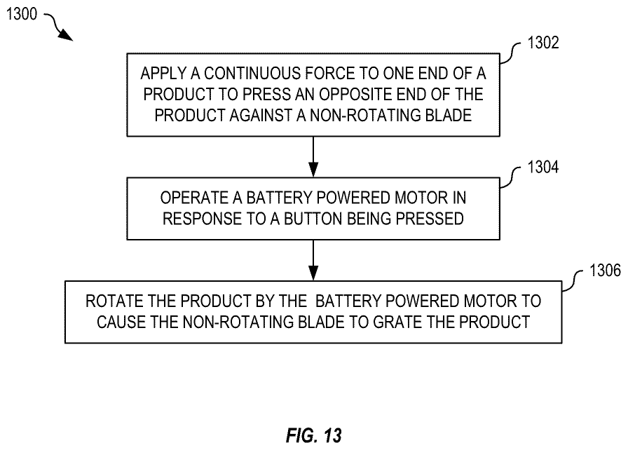

FIG. 13 is a flowchart illustrating one example method 1300 for grating a product with a handheld grater, in embodiments. Method 1300 is implemented by handheld battery powered grater 100 of FIG. 1.

In block 1302, method 1300 applies a continuous force to one end of a product to press an opposite end of the product against a non-rotating blade. In one example of block 1302, spring 506 provides a continuous force to press a product within product container 104 against non-rotating blade 604. In block 1304, method 1300 activates a battery powered motor in response to a button being pressed. In one example of block 1304, motor 702 is activated in response to button 106 being pressed by a user of handheld battery powered grater 100. In block 1306, method 1300 rotates the product by the battery powered motor to cause the non-rotating blade to grate the product. In one example of block 1306, motor 702 causes container bucket 508, containing the product, to rotate such that non-rotating blade 604 grates the product.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A handheld battery powered grater, comprising:
a power handle with a battery, a motor, and a button; and
a product container removably coupled with the power handle and having:
an internal mechanism that rotates; and
a non-rotating blade positioned at a distal end of the product container from the power handle;
wherein activation of the button transfers electrical power from the battery to the motor to cause the internal mechanism to rotate such that a product within the product container is rotated against the non-rotating blade.

2. The handheld battery powered grater of claim 1, the power handle and the product container removably coupling with a rotational lock mechanism.

3. The handheld battery powered grater of claim 1, the internal mechanism comprising:
a product clamp;
a pressor; and
a spring positioned between the product clamp and the pressor to cause the pressor to press the product against the non-rotating blade.

4. The handheld battery powered grater of claim 1, the product container comprising a drive shaft coupling the internal mechanism with the power handle when the power handle is coupled with the product container.

5. The handheld battery powered grater of claim 1, the product container comprising a blade press ring for immovably securing the non-rotating blade at the distal end of the product container.

6. The handheld battery powered grater of claim 5, the non-rotating blade press ring being removable to access the non-rotating blade.

7. The handheld battery powered grater of claim 1, the internal mechanism removably coupling with an internal sleeve of the product container by a rotational lock mechanism.

8. The handheld battery powered grater of claim 7, the internal mechanism being removed to add the product to the product container.

9. The handheld battery powered grater of claim 1, further comprising a sealing cap for sealing a lower end of the product container when not in use.

10. The handheld battery powered grater of claim 9, the sealing cap comprising:
a top cover; and
a bottom cover that form an enclosed volume sized to store one or more additional blades.

11. The handheld battery powered grater of claim 10, the sealing cap including a rotational lock mechanism to couple with the product container.

12. The handheld battery powered grater of claim 1, the product container being formed of a material suitable for cleaning by a dishwasher.

13. The handheld battery powered grater of claim 1, further comprising a stand for holding either the handheld battery powered grater or the power handle.

14. The handheld battery powered grater of claim 13, the battery being rechargeable, the stand comprising a outer shell and a base that couple together using a rotational lock mechanism to form a chamber with a spool for storing a recharging cable.

15. The handheld battery powered grater of claim 14, the stand comprising an aperture to pass a plug of the recharging cable to connect with a power socket of the power handle while the power handle is positioned within the stand.

16. The handheld battery powered grater of claim 14, the base including a rotational lock mechanism for coupling with a sealing cap that seals a lower end of the product container.

17. A method for grating a product, comprising:
applying a continuous force to one end of a product to press an opposite end of the product against a non-rotating blade;
activating a battery powered motor in response to a button being pressed; and
rotating the product by the battery powered motor to cause the non-rotating blade to grate the product.

18. The method of claim 17, wherein the continuous force is provided by a spring that is compressed by the product when an internal mechanism containing the spring is coupled with a container bucket of a product container holding the product.
